(19) United States
(12) Patent Application Publication
(10) Pub. No.: US 2024/0132673 A1
(43) Pub. Date: Apr. 25, 2024

(54) POLYMER WITH IMPROVED FRACTURE TOUGHNESS

(71) Applicant: NORWEGIAN UNIVERSITY OF SCIENCE AND TECHNOLOGY (NTNU), Trondheim (NO)

(72) Inventors: Yizhi ZHUO, Trondheim (NO); Jianying HE, Trondheim (NO); Zhiliang ZHANG, Trondheim (NO)

(21) Appl. No.: 18/283,693

(22) PCT Filed: Mar. 22, 2022
(86) PCT No.: PCT/EP22/57459

§ 371 Date: Sep. 22, 2023

(30) Foreign Application Priority Data
Mar. 22, 2021 (GB) 2103976.3

(51) Int. Cl. C08G 77/458; C08L 83/10

(52) U.S. Cl. CPC C08G 77/458; C08L 83/10; C08L 2207/04

(57) ABSTRACT

A polymer comprising a structural unit of formula (I). wherein each X is independently a C₁₋₁₀ hydrocarbylene group optionally comprising 1 to 6 heteroatoms: Y is a C₂₋₂₀ hydrocarbylene group: Z is a C₁₋₂₀ hydrocarbylene group optionally comprising 1 to 6 heteroatoms or a linking group comprising one or more alkylene glycol or ethylene diamine groups: n is 12 to 100; and m is 2 to 1000.

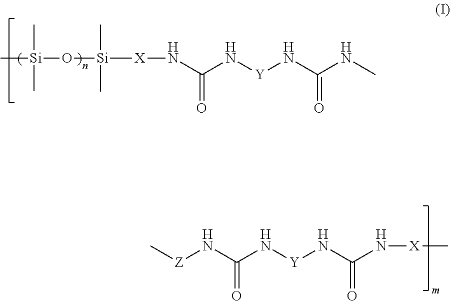

### FIELD OF THE INVENTION

The present invention relates to a polymer, particularly an elastomeric polymer, having an improved balance of stiffness and fracture toughness. The invention also provides a polymer composition comprising said polymer, the use of said polymer or a polymer composition comprising said polymer in the manufacture of films, wearable electronics, flexible electronics, soft robots, vehicles, in construction, and in soft-lithography. The invention also relates to an article comprising said polymer or polymer composition, and to a method of preparing said polymer.

### BACKGROUND

Soft materials are widely used in both classical fields of engineering and emerging areas such as wearable electronics, flexible electronics and soft robots. In many of these applications, materials must not only exhibit high stiffness but also high toughness.

One class of commonly used soft materials is elastomers, in particular synthetic unfilled elastomers. Such elastomers are often crosslinked to improve their mechanical properties. Conventionally, this involves the formation of covalent bonds between polymer chains which act to prevent polymer chains from sliding easily past one another. Covalently crosslinked elastomers therefore generally have improved stiffness compared to non-crosslinked elastomers.

Despite the versatility of covalently crosslinked polymers however, the provision of a soft polymer having a combination of high stiffness and high toughness remains difficult to achieve. Whilst increasing the cross-linking density of conventional covalently cross-linked polymers tends to lead to higher stiffness, the resultant material is often quite brittle i.e. having low toughness.

In the past, homogeneous networks and energy dissipative mechanisms have been adopted to toughen elastomers. Elastomers with more homogeneous networks can delay the nucleation of fracture induced by the rupture of shorter chains, thus leading to higher stretchability and toughness. However, homogeneous networks that are built by tetrahedron-like macromonomers or which contain sliding cross-links exhibit limited enhancement in toughness because of the absence of other energy dissipative mechanisms. Moreover, the energy dissipative networks which can be obtained by incorporating sacrificial bonds such as partially pre-stretched chains, metal-ligand coordination, Coulombic interactions and hydrogen bonding often present high toughness but low stiffness due to the inherently weak nature of these interactions.

In order to overcome this limitation, polymers having repeating units comprising multiple groups capable of hydrogen bonding have been proposed. To date however, polymers have been limited to having three, four or six hydrogen bonding groups per repeating unit due to the difficulty in synthesising polymers having repeating units comprising multiple hydrogen bonding sites. The high density of hydrogen bonding sites in such polymers often leads to the aggregation of polymer chains during synthesis, which can cause precipitation of the polymer from solution during synthesis thereby leading to failure of the synthesis. As a result, there is still a need for new strategies for obtaining polymers having multiple hydrogen bonding sites that do not suffer from the drawbacks of the prior art.

US 2019/0106544 describes an elastomer material comprising a flexible polymer backbone based on elastomers formed of PDMS with various ratios of 4,4′-methylenebis(phenyl urea) (first moiety) and isophorone (second moiety) with Mw greater than 1200.

CN 112210064 describes a supramolecular polymer PDMS-Cat-M, which is a complex ligand compound of PDMS-Cat and a metal ion M. The ligand compound PDMS-cat has only two consecutive urea groups in the polymer backbone.

CN 108610466 describes a polysiloxane-polyurea elastomer in which the repeating unit comprises urea groups in repeating units of three. In the linker the bridging atoms between urea groups are hydrocarbon based.

Rieche et al (Polymers 2021, Vol. 13(2) describes hard segment content and diisocyanate structure on the transparency and mechanical properties of soft PDMS-based urea elastomers.

In a first embodiment. the present inventors have now provided a polymer having a repeating unit comprising at least eight hydrogen bonding sites, and which has both excellent stiffness and toughness. The polymer can be used to form soft materials which are particularly suited for use in applications such as wearable electronics, flexible electronics and soft robots. The polymer of the invention does not suffer from aggregation during synthesis.

### SUMMARY OF THE INVENTION

Thus, viewed from one aspect, the invention provides a polymer comprising a structural unit of formula (I):

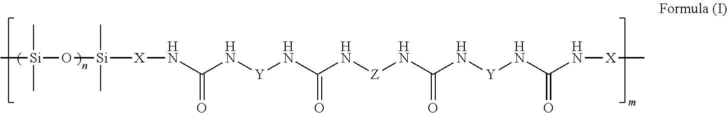

wherein each X is independently a C₁₋₁₀ hydrocarbylene group optionally comprising 1 to 6 heteroatoms;
Y is a C₂₋₂₀ hydrocarbylene group;
Z is a C₁₋₂₀ hydrocarbylene group optionally comprising 1 to 6 heteroatoms or a linking group comprising one or more alkylene glycol or ethylene diamine groups;
n is 12 to 100; and
m is 2 to 1000.

In one embodiment the polymer is an elastomer.

Viewed from another aspect, the invention provides a polymer composition comprising the polymer as hereinbefore defined.

Viewed from another aspect, the invention provides the use of a polymer or polymer composition as hereinbefore defined in the manufacture of films, wearable electronics, flexible electronics, soft robots, vehicles, in construction, and in soft-lithography.

Viewed from another aspect, the invention provides an article, such as a film, wearable electronic device, flexible electronic device, soft robot or a vehicle, comprising the polymer or polymer composition as hereinbefore defined.

Viewed from another aspect, the invention provides a method of preparing a polymer as hereinbefore defined, comprising the steps of:
(i) reacting a compound of formula (A) with a compound of formula (B) to form an intermediate of formula (C);
(ii) reacting said intermediate of formula (C) with a chain extender of formula (D)

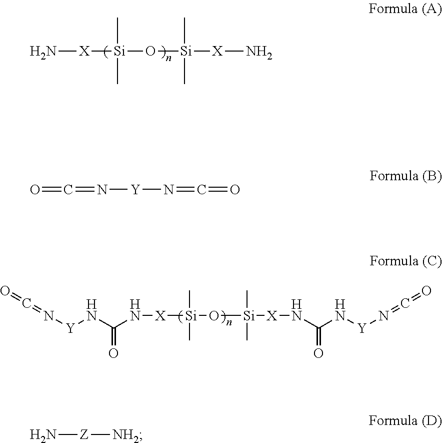

wherein each X is independently a C₁₋₁₀ hydrocarbylene group optionally comprising 1 to 6 heteroatoms;
Y is a C₂₋₂₀ hydrocarbylene group;
Z is a C₁₋₂₀ hydrocarbylene group optionally comprising 1 to 6 heteroatoms or a linking group comprising one or more alkylene glycol or ethylene diamine groups; and
n is 12 to 100.

Alternatively viewed, the invention relates to a polymer obtainable by reacting
(i) a compound of formula (A) with a compound of formula (B) to form an intermediate of formula (C);
(ii) reacting said intermediate of formula (C) with a chain extender of formula (D)

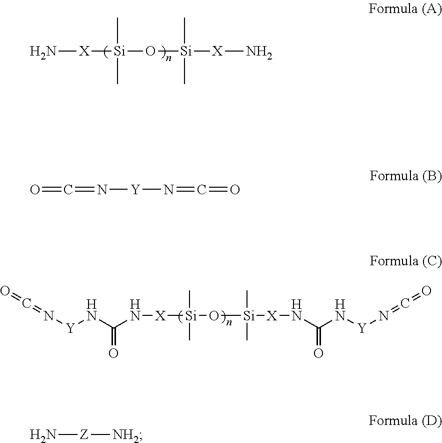

wherein each X is independently a C₁₋₁₀ hydrocarbylene group optionally comprising 1 to 6 heteroatoms;
Y is a C₂₋₂₀ hydrocarbylene group;
Z is a C₁₋₂₀ hydrocarbylene group optionally comprising 1 to 6 heteroatoms or a linking group comprising one or more alkylene glycol or ethylene diamine groups; and
n is 12 to 100.

### DEFINITIONS

The term heteroatom in this case refers to N, O, or S. If a group comprises N then that heteroatom may also contain H to make NH.

The term “hydrocarbylene group” is used herein to designate a divalent hydrocarbon radical. Unless otherwise indicated, said hydrocarbon radical consists of hydrogen and carbon atoms.

### DETAILED DESCRIPTION OF THE INVENTION

The present invention relates to a novel polymer having an excellent balance of toughness and stiffness. The polymer comprises polydimethylsiloxane (PDMS) sections and polyurea sections. The polymer comprises a structural unit of formula (I) as illustrated below:

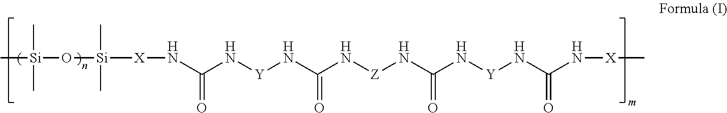

wherein each X is independently a C₁₋₁₀ hydrocarbylene group optionally comprising 1 to 6 heteroatoms;
Y is a C₂₋₂₀ hydrocarbylene group;
Z is a C₁₋₂₀ hydrocarbylene group optionally comprising 1 to 6 heteroatoms or a linking group comprising one or more alkylene glycol or ethylene diamine groups;
n is 12 to 100; and
m is 2 to 1000.

The structural unit of formula (I) comprises at least 8 groups capable of acting as hydrogen-bond donors (i.e. the —NH—groups) and at least 4 groups capable of acting as hydrogen bond acceptors (i.e. the C═O groups). As a result, polymers comprising the structural unit of formula (I) are highly capable of forming hydrogen bonds between chains. The formation of hydrogen bonds between chains makes it more difficult for polymer chains to slide past each other and hence the stiffness of the material is increased. In addition, the high density of hydrogen bonding provides an additional energy dissipation mechanism to the polymer, which results in a high toughness.

The stiffness and toughness of the polymer are further enhanced by the formation of hydrogen bonding domains i.e. regions of the material where the hydrogen bonding regions of several different chains align and form bonding interactions with each other.

### Compounds of Formula (A)

The polymer comprises the residue of a monomer of formula (A)

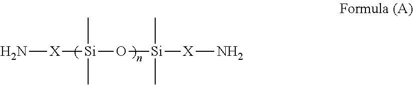

as hereinbefore defined.

In one embodiment, each X is independently a C₁₋₆ hydrocarbylene group, preferably a C₁₋₄ hydrocarbylene group, such as a C₃ hydrocarbylene group. The term “independently” is used herein to indicate that each X in the structural unit of formula (I) may be the same or different. In a preferred embodiment, each X is the same.

In one embodiment, each X is independently a C₁₋₁₀ alkylene, C₁₋₁₀ heteroalkylene, C₄₋₁₀ cycloalkylene, C₂₋₁₀ alkenylene, C₂₋₁₀ heteroalkenylene, C₄₋₁₀ cycloalkenylene, C₆₋₁₀ arylene or C₆₋₁₀ heteroarylene group. In a preferred embodiment, each X is independently a C₁₋₁₀ alkylene or C₁₋₁₀₋ heteroalkylene, more preferably a C₁₋₁₀ alkylene group.

If a heteroatom is present in group X then the heteroatom is preferably O. If present, the heteroatom is preferably not adjacent the Si atom or N atom. If present, the O preferably forms an ether group within the hydrocarbylene group. Most preferably however there is no heteroatom present in group X.

Each X may independently be linear or branched. In a preferred embodiment, each X is linear. In a most preferred embodiment, each X is a C₁₋₆ alkylene group, such as a methylene, ethylene, n-propylene, or n-butylene group. In one embodiment X is an n-propylene group.

In a most preferred embodiment, each X is the same and is linear and is a C₁₋₆ alkylene group, such as a methylene, ethylene, n-propylene, or n-butylene group. In one embodiment both X′s are an n-propylene group.

In formula A, “n” represents the number of repeat units in the PDMS segment of the polymer. The value of “n” in the structural unit of Formula (I) is from 12 to 100. In one embodiment, n is greater than 12, such 15 or more, for example 30 or more. In some embodiments, n is less than 100, such as 80 or less, for example 75 or less. In one embodiment, the value of n is in the range of 15 to 80, such as 20 to 80, more preferably in the range of 25 to 75. In a preferred embodiment, n is in the range of 30 to 70, such as 35 to 70.

The molecular weight of formula (A) is preferably at least 1200, such as at least 1500. The upper limit may be 10,000.

Alternatively viewed, the molecular weight of the siloxy repeating unit (i.e. the repeating unit within the brackets) in formula (A) is preferably at least 1000, such as at least 1200, especially at least 1500. The upper limit may be 10,000.

In general, the shorter the PDMS unit the stiffer the polymer. Longer PDMS units lead to softer polymers. Formula (A) is therefore a macromonomer.

### Compound B

The polymer of the invention also contains the residue of a compound of formula B:

O═C═N—Y—N═C═O Formula (B)

Y in the formula (B) is a C₂₋₂₀ hydrocarbylene group, such as C₂₋₁₂ hydrocarbylene group. In one embodiment, Y is a C₆₋₂₀ hydrocarbylene group, preferably a C₆₋₁₂ hydrocarbylene group, such as a C₁₀ hydrocarbylene group. Y may be a linear, branched, cyclic or aromatic group. There may be multiple such groups present, e.g. two phenyl groups linked by an alkyl group.

In one embodiment, Y is an C₂₋₂₀ alkylene, C₄₋₂₀ cycloalkylene, C₂₋₂₀ alkenylene, C₄₋₂₀ cycloalkenylene, or C₆₋₂₀ arylene group, preferably an C₂₋₂₀ alkylene or C₂₋₂₀ cycloalkylene group, more preferably a C₂₋₂₀ cycloalkylene group. The term cycloalkylene implies here the presence of a saturated cyclic ring in the substituent. The ring may still however carry other hydrocarbyl groups as alkyl groups. The term cycloalkylene therefore covers methylcyclohexylene for example. Similarly, the term arylene is intended to cover the likes of toluene.

In one embodiment, Y is a C₆₋₁₂ cycloalkylene group, preferably a branched C₆₋₁₂ cycloalkylene group, such as 1,1,3,3-tetramethylcyclohexylene.

Isocyanates of interest include methylenebis(phenyl isocyanate) (MDI), toluene diisocyanate (TDI), hexamethylene diisocyanate (HDI), naphthalene diisocyanate (NDI), methylene bis-cyclohexylisocyanate (HMDI) (hydrogenated MDI), diisocyanatobutane (BDI), 1,3-Bis(1-isocyanato-1-methylethyl)benzene (BPDI) and isophorone diisocyanate (IPDI). In one embodiment, the diisocyanate of formula (B) is isophorone diisocyanate.

### Compounds of Formula (D)

The polymer of formula (I) also contains the residue of a chain extender of formula (D). The chain extender reacts with the intermediate (C) to create a further urea linkage and hence the polymer of formula (I).

H₂N—Z—NH₂ Formula (D)

In a first embodiment Z is a C₁₋₂₀ hydrocarbylene group optionally comprising 1 to 6 heteroatoms. In one embodiment, Z is a C₂₋₁₂ hydrocarbylene group, preferably a C₂₋₁₀ hydrocarbylene group, such as a C₂₋₆ hydrocarbylene group.

In one embodiment, Z is an C₁₋₂₀ alkylene or C₁₋₂₀ heteroalkylene, preferably a C₁₋₁₀ alkylene or C₂₋₁₀ heteroalkylene group, more preferably an C₃₋₁₀ heteroalkylene group.

Z may be linear or branched. In a preferred embodiment Z is linear.

In any embodiment of the invention Z preferably contains a heteroatom, especially an N or O atom, such as NH group. The Z group is preferably an ether or polyether with multiple ether groups.

In one embodiment, Z comprises 1 to 6 heteroatoms i.e. atoms other than C or H so as to form a heterohydrocarbylene group. In a preferred embodiment, Z comprises 1 to 4 heteroatoms, preferably 1 to 3 heteroatoms, such as 2 heteroatoms. In a preferred embodiment, each heteroatom is the same. In a most preferred embodiment all heteroatoms are O.

In one embodiment therefore, Z is a linear C₂₋₁₂ alkylene group optionally comprising 1 to 6 heteroatoms wherein at least one, preferably all, heteroatoms are O. In one embodiment, Z is a C₃₋₈ alkylene group comprising 1 to 3 heteroatoms, more preferably a linear C₃₋₈ alkylene group comprising 1 to 3 O atoms.

Any heteroatoms present are preferably not adjacent the terminal amino groups. Preferably, the heteroatom is an O atom and forms an ether group.

In another embodiment the group Z is a linking group comprising one or more alkylene glycol or ethylene diamine units. Preferably, Z comprises one or more propylene or ethylene glycol units. In some embodiments, the Z group may comprise multiple alkylene glycol groups or ethylene diamine groups, such as a poly(alkylene oxide) chain with 2 to 20 repeating groups.

Z is preferably comprises at least one ethylene glycol group or at least one ethylene diamine group. It will be appreciated that the O or N atom in such a group should not be adjacent the NH₂ groups and hence an alkyl chain, e.g. methylene or ethylene may separate the terminal —NH₂ from the O or N atom of the alkylene glycol or ethylene diamine.

Preferred compounds of formula D include

NH₂-L1-(OCH₂CH₂O)_{q}-L2-NH₂

NH₂-L1-(NHCH₂CH₂NH)_{q}-L2-NH₂
wherein q is 1 to 10 and L1 and L2 are independently a C₁₋₄ alkylene chain.

In one embodiment, q is 1. In one embodiment L1 and L2 are ethylene.

In one embodiment, L1 and L2 are the same.

Suitable compounds of formula (D) include 1,2-bis(2-aminoethoxy)ethane and triethylenetetramine.

Other preferred compounds include

NH₂CH₂(CH₂)_{w}CH₂NH₂
where w is 0-10.

The value “m” in Formula (I) represent the number of repeat units of the structural unit as a whole. The value of m is not particularly limited and may generally be anywhere in the range of 2 to 1000. In one embodiment, m is greater than 5, preferably greater than 10. In one embodiment, m is less than 1000, preferably less than 500, such as less than 100. In a preferred embodiment, m is in the range of 2 to 100, preferably 2 to 50, such as 2 to 10.

The polymer according to the present invention has an excellent balance of stiffness and toughness. In one embodiment the polymer has a Young's modulus of greater than 1 MPa, preferably greater than 2 MPa, more preferably greater than 3 MPa, when measured according to the protocol given in the “Determination Methods” section under the heading “Determination of Fracture toughness and Young's modulus”. In some embodiments, the Young's modulus of the polymer is greater than 10 MPa. In one embodiment, the Young's modulus of the polymer is in the range of 1 to 15 MPa, preferably in the range of 2 to 15 MPa, more preferably in the range of 3 to 12 MPa.

In one embodiment, the polymer has a fracture toughness of greater than 5 kJ/m², preferably greater than 10 kJ/m², such as greater than 15 kJ/m² when measured according to the protocol given in the “Determination Methods” section under the heading “Determination of Fracture toughness and Young's modulus”. In some embodiments, the fracture toughness is as high as 16 kJ/m², sometimes as high as 17 KJ/m². In one embodiment, the fracture toughness of the polymer is in the range of 5 to 20 KJ/m², preferably in the range of 10 to 18 kJ/m², more preferably in the range of 16 to 18 KJ/m².

In one preferred embodiment, the polymer simultaneously has a fracture toughness of greater than 5 kJ/m², preferably greater than 10 kJ/m², such as greater than 15 kJ/m², and a Young's modulus of greater than 1 MPa, preferably greater than 2 MPa, more preferably greater than 3 MPa, such as greater than 10 MPa.

In one embodiment, the polymer is an elastomer. The polymer will therefore return to its original form after deformation. In FIG. 4d, the polymer of the invention is subjected to cyclic loading and unloading forces with different maximum tensile strain—the polymer is elastic and returns to its original form after the forces are removed. FIG. 5 also demonstrates the elasticity of the polymers of the invention.

In one embodiment the polymer is a thermoplastic polymer. In one embodiment the polymer is not covalently crosslinked.

In one embodiment, the polymer has a melting point of at least 50° C., preferably at least 56° C., e.g. 50 to 110° C. Melting points can be determined using Modulated DSC as described in the test methods below.

In one aspect, the polymer forms part of a polymer composition. The polymer composition comprises the polymer having the structural unit as hereinbefore defined, and optionally further additives. Examples of suitable additives include antioxidants, fillers, UV stabilizers, anti-fogging agents, UV absorbers, IR reflectors, acid scavengers, nucleating agents, anti-blocking agents, slip agents etc. In one embodiment, however, the polymer composition is unfilled. In one embodiment, the polymer composition comprises greater than 95%, such as at least 98%) of the polymer having the structural unit of Formula (I).

### Method for Preparing the Polymer

In a further aspect, the present invention provides a method of preparing the polymer hereinbefore described. The method comprises the steps of (i) reacting an amino-terminated PDMS compound of formula (A) with a diisocyanate of formula (B) to form an intermediate of formula (C); (ii) reacting said intermediate of formula (C) with a chain extender of formula (D)

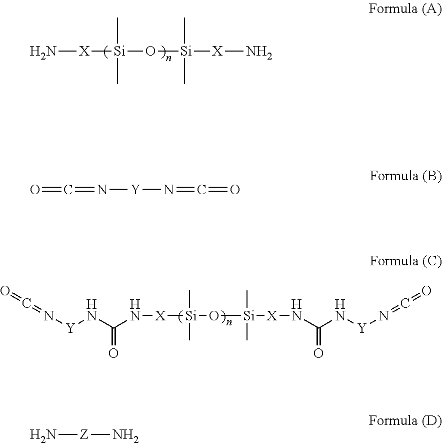

wherein X, Y, Z and n are as hereinbefore defined.

In one embodiment, the amino-terminated PDMS of formula (A) is an amino-alkyl terminated PDMS, such as an aminomethyl, aminoethyl or aminopropyl terminated PDMS. In a preferred embodiment, an aminopropyl terminated PDMS is used.

The compound of formula (B) is a di-isocyanate which reacts with the amino-terminated PDMS of formula (A). In one embodiment, the reaction takes place in solution. Suitable solvents for effecting this reaction are known to the person skilled in the art. In one embodiment an aprotic solvent such as tetrahydrofuran (THF) may be used. In one embodiment, at least twice as much of the diisocyanate of formula (B) is used in the reaction as the amino-terminated PDMS of formula (A), according to the stoichiometric amount of each component. In one embodiment, the diisocyanate of formula (B) is present in excess.

The reaction of the amino-terminated PDMS compound of formula (A) with the diisocyanate of formula (B) leads to the formation of an intermediate (C) which may be isolated and analysed. This intermediate forms another aspect of the present invention.

Thus, viewed from another aspect the invention provides a compound of formula (C)

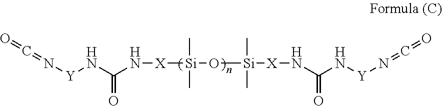

wherein X and Y are as hereinbefore defined.

In the method according to the present invention, the intermediate is reacted with a chain extender of formula (D) to form the polymer having the structural unit of formula (I). In one embodiment the reaction takes place in solution, preferably with an aprotic solvent such as THF. In one embodiment, the solvent is the same as that used in the step of reacting the amino-terminated PDMS compound of formula (A) with the diisocyanate of formula (B).

It is preferred if stoichiometric amounts of the compound (D) and intermediate (C) are used.

In general, the chemistry required to prepare the compound of formula (I) is based on well-known polyurea reactions. These can be effected under room temperature and pressure and the skilled person is able to carry out the necessary reactions using his common general knowledge.

Once compounds of formula (I) are formed, they spontaneously adopt a configuration in which hydrogen bonding occurs as depicted in FIG. 4 below.

As there are multiple N—H groups and multiple C═O groups in the molecule, numerous hydrogen bonding opportunities are present. The hydrogen bonds are strong and reversible. We achieve stiffness and toughness simultaneously via this mechanism. There should be at least eight hydrogen bonding cross-links in the compound of formula (I) but there can be many more.

The combination of homogeneous networks and energy dissipative mechanism synergistically endows the elastomer with ultrahigh toughness, while the strong and reversible crosslinks that formed by locally dense hydrogen bonds further enhance the toughness and provide high stiffness.

The hydrogen bonds assemble into strong hydrogen bonding domains, which enhance the toughness and stiffness simultaneously. As a result, the prepared elastomers exhibit significant improvement in fracture toughness and stiffness in comparison with other unfilled elastomers. In FIG. 4c, we compare our data to a large number of commercial elastomer materials.

To achieve a homogeneous polymer network with locally dense hydrogen bonding crosslinks whilst avoiding the aggregation and precipitation of the polymer during the synthesis because of the dense hydrogen bonds, a chain extension reaction is used.

Extraordinarily, PDUE5000 presents high Young's modulus of 3.2 MPa and high fracture toughness of 16434 J/m² simultaneously. More strikingly, PDUE3000, which has shorter PDMS macromonomers, exhibits even higher Young's modulus of 10.3 MPa and similar fracture toughness of 17016 J/m², showing the remarkable improvement to break through the trade-off.

The presence of hydrogen bonding is demonstrated via temperature dependent FTIR. FTIR spectra are recorded as the temperature is raised from 30° C. to 150° C. (within which range there is no degradation as confirmed by thermogravimetric analysis). The evolution of FTIR spectrum as temperature increases from 30° C. to 150° C. indicates the dissociation of hydrogen bonds and generation of free C═O and free N—H.

The hydrogen bonding preferably occurs through atoms present in the backbone of the compound of formula (I). In some embodiments, all H-bonding occurs through groups present in the backbone of the polymer.

Compounds of formula (I) can form articles that are transparent and defect-free. At the atomic scale, the formed hydrogen bonds will increase the friction of polymer chains resulting in enhanced stiffness and will be broken to dissipate energy during stretch leading to increased toughness. At molecular scale, more homogeneous polymer networks that derived from the defined macromolecular distribute the stress to each polymer chain, thereby reducing the stress concentrations, consequently, enhancing the stretchability and delaying fracture. At the nanoscale, the formed hydrogen bonding domains and the resulted bicontinuous structure can increase the stiffness by restricting the network mobility and improve the toughness by dissipating mechanical energy during transformation between different configurations. At the macroscale, the absence of macroscopic defect can delay fracture and endow the materials with large extensibility, thus high toughness.

In summary, the present polymer offers homogeneous and energy dissipative networks to toughen and stiffen unfilled elastomers by introducing locally dense hydrogen bonding sites into linear PDMS chains via the chain extension reaction.

The prepared elastomers demonstrated a significant improvement in both stiffness and toughness due to the strong and reversible hydrogen bonds as well as the assembled hydrogen bonding domains. The strong hydrogen bonding domains can endow the elastomers with high stiffness, while their transformation, realignment, slippage and breakage during stretching can dissipate large energy and release stress concentration, therefore leading to ultrahigh fracture toughness. Moreover, during stretching of a pre-cracked elastomer, the alignment of hydrogen bonding domains along the direction perpendicular to the stretching as well as the stiffness mismatch between hydrogen bonding domains and PDMS-rich phase can induce the crack deflection, which can further dissipate energy and alleviate local stress, and thus enhance the fracture toughness.

More generally, the invention relates to a polymer in which polydimethylsiloxane macromonomer units are separated from each other by a group comprising at least 2, such as at least 4 urea (NH—CO—NH) groups and additional polar groups.

Thus viewed from another aspect the invention provides a polymer of comprising a repeating unit of formula (II)

-[PDMS-Q]- (II)
wherein PDMS is a polydimethylsiloxane having an Mw of at least 1200 and Q is a group comprising at least two urea (NH—CO—NH) groups and at least one CH₂—O—CH₂ or CH₂—NH—CH₂ group in the backbone of the polymer.
Q may contain at least 4 urea groups.

Viewed from another aspect the invention provides a polymer of comprising a repeating unit of formula (IIa)

-[PDMS-Q]- (IIa)
wherein PDMS is a polydimethylsiloxane having an Mw of at least 1200 and Q is a group comprising at least two urea (NH—CO—NH) group, and at least one alkylene glycol or alkylene diamine group in the backbone of the polymer.
Q may contain at least 4 urea groups.

In one embodiment there are preferably 4 urea groups only in Q. Preferably, there are no more than 60 backbone atoms separating PDMS units, such as 20 to 50 backbone atoms, e.g. 30 to 50. If the backbone contains a ring then the number of backbone atoms is determined by counting around the shortest route around the ring.

Preferably Q comprises the group

-L1-(OCH₂CH₂O)_{q}-L2- or -L1-(NHCH₂CH₂NH)_{q}-L2-wherein
wherein q is 1 to 10 and L1 and L2 are independently a C₁₋₄ alkylene chain. Preferably q is 1 and L1 and L2 are ethylene.

Preferably Q comprises the structural unit

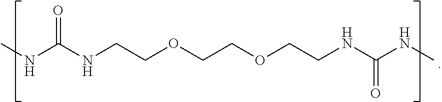

The nature of the chain extender is important for the physical and mechanical properties of the polymer. The polymers of this aspect of the invention comprise multiple hydrophilic urea groups but also a hydrophobic group Y between urea groups. The use of a polar extender incorporating heteroatoms such as an alkylene glycol chain allows for the formation of hydrogen bonds. The formed hydrogen bonds can dissipate energy during loading, further enhancing the mechanical properties of the polymer. The high fracture toughness and stiffness of the polymers of the invention is believed to be due to the formation of strong hydrogen bonding domains, which may act to dissipate energy when the material is stretched. The presence of a polar group Z enhances this effect.

### Applications

In one aspect, the present invention provides the use of a polymer as hereinbefore defined in the manufacture of films, wearable electronics, flexible electronics, soft robots, vehicles, in construction, or in soft-lithography. In another aspect, the present invention provides an article comprising the polymer or polymer composition as previously defined. In one embodiment, said article is selected from the group consisting of films, wearable electronic devices, flexible electronic devices, soft robots and vehicles.

### BRIEF DESCRIPTION OF THE FIGURES

FIG. 1: FIG. 1a shows stress-strain curves for notched and unnotched samples of the polymer according to the present invention. FIG. 1b shows the stress strain curves for unnotched samples of the polymer in the low strain region.

FIG. 2: FIG. 2 shows SEM images of pre-cracked specimen of PDUE5000 during loading and unloading. In FIGS. 2a-c the pre-crack is opening and blunting in the initial stretching (Δd=0.1-3.0 mm, scale bar: 1.00 mm). In FIGS. 2d and 2e a fibre-like flaw generates at the edge of the specimen (scale bar: 1.00 mm and 400 μum respectively). In FIGS. 2f-h, more flaws generate and propagate along the direction parallel to the stretching (scale bar: 1.00, 1.00 and 2.00 mm respectively). In FIGS. 2i and 2j the cracks are observed clearly during unloading (scale bar: 1.00 mm and 200 μm respectively). In FIGS. 2k and 2l, crack deflection and branching are observed in the unloading state. The cracks turn around rather than propagate in the original direction (scale bar: 1.00 mm and 100 μm respectively).

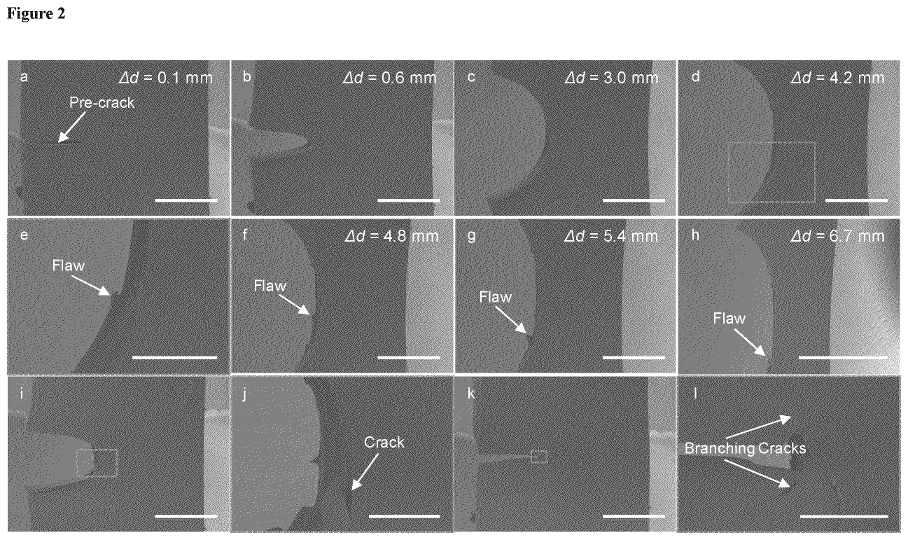

FIG. 3: FIG. 3 shows the thermogravimetic analysis (TGA) curve for PDUE5000 of the polymer.

FIG. 4. FIG. 4a shows a theoretical depicted of hydrogen bonding in the claimed molecules. In FIG. 4(b), PDUE molecule consists of flexible chains (blue) and eightfold hydrogen-bonding motifs, forming very homogeneous networks. In FIG. 4(c) a toughness-modulus diagram of PDUE (black stars) and reference elastomers. The dash line indicates the trade-off between toughness and stiffness for the reference materials. FIG. 4d demonstrates the elastic behaviour of the polymers of the invention. Even at different stresses and strains, the polymer is elastic and returns to its original form when the deformation forces are removed.

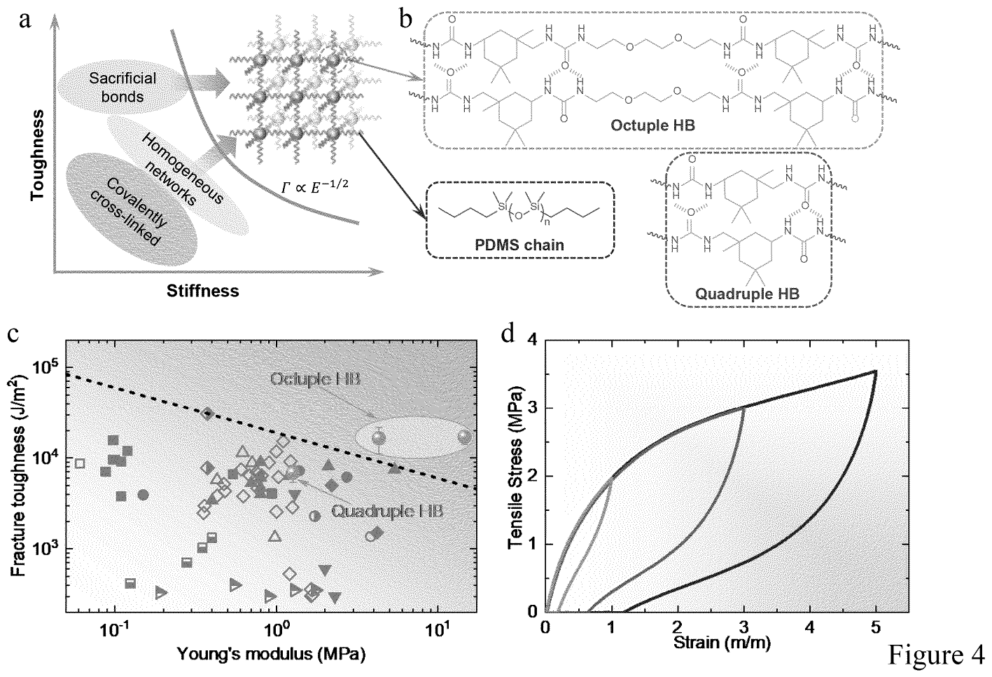

FIG. 5. (a) shows a typical cyclic loading/unloading curves of PDUE. The top line is the loading curve, while the lower line is the unloading curve. The shaded area between the loading and unloading curves denotes the energy dissipation. Recovered strain is denoted by the black arrow. (b) Energy dissipations (left hand columns) and dissipation ratios (right hand columns) for PDUE examples at different maximum strains. The dissipation ratio (right hand columns) is the ratio between energy dissipation and loading energy (i.e., the area under the loading curve). (c) Recovered strains (left hand column) and shape recovery ratios (right hand columns) at different maximum strains. The shape recovery ratio is the ratio between recovered strain and maximum strain.

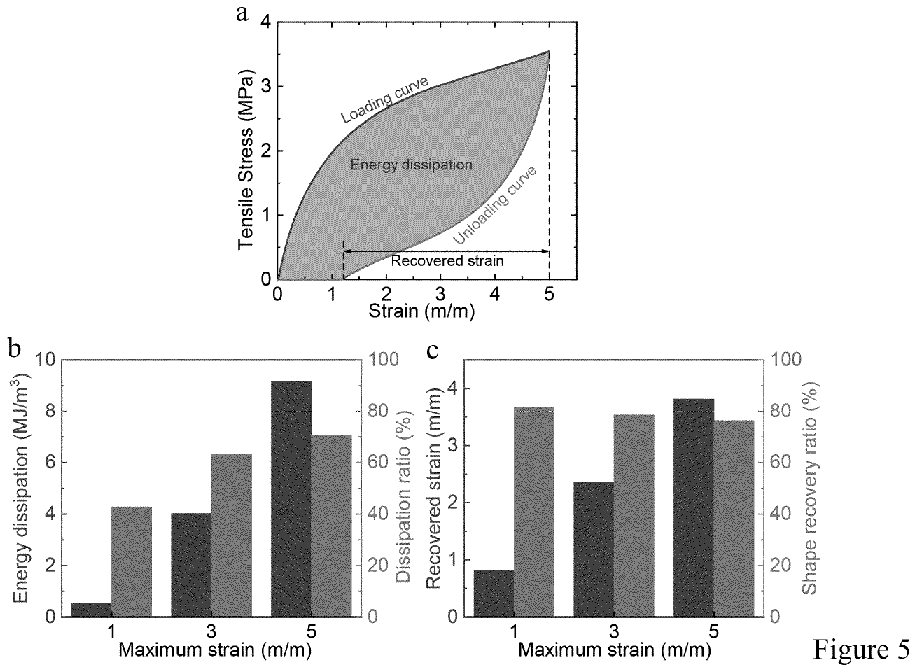

FIG. 6. shows the melting point of the PDUE. The peaks on the reversing curve and non-reversing curve are attributed to the melting point of the hydrogen bonding domain (roughly)77° C.).

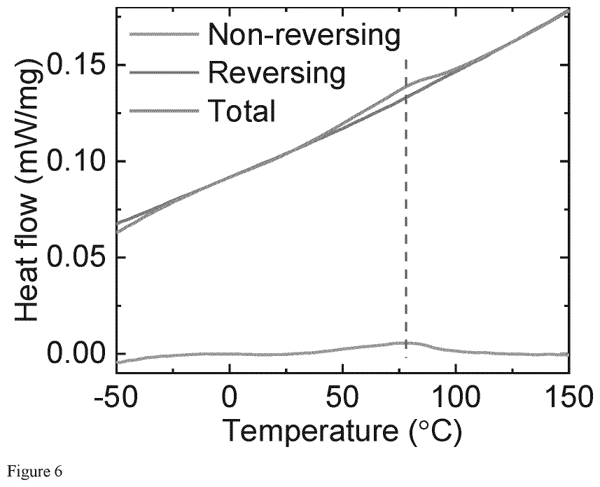

### DETERMINATION METHODS

### Determination of Fracture Toughness and Young's Modulus

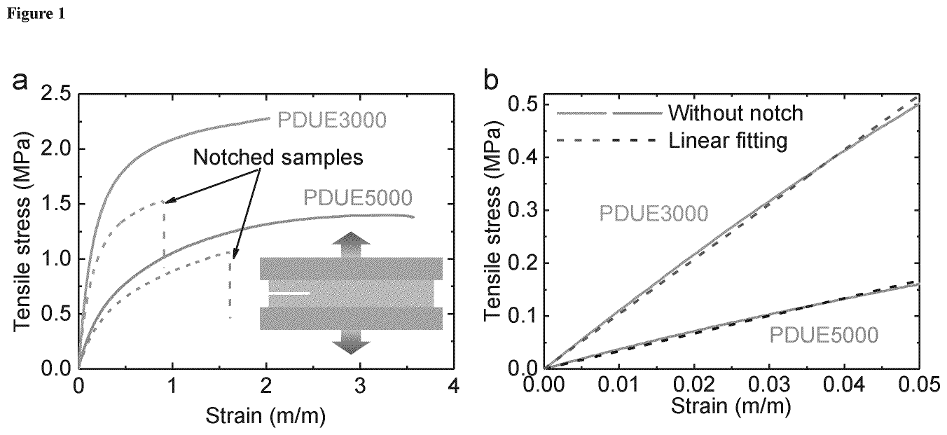

The fracture toughness (T) is characterized by the pure shear test proposed by Rivlin and Thomas (Rivlin, R. S. & Thomas, A. G. Rupture of rubber. I. Characteristic energy for tearing. Journal of Polymer Science 10, 291-318, doi: 10.1002/pol.1953.120100303 (1953)), which has been widely adopted to characterize fracture of soft materials. The experiments were conducted on a uniaxial tensile test machine (Instron 5944 with a 2 kN load cell). A notch of 15 mm in length was made in a rectangular specimen of the material (Width: ˜60 mm; thickness: ˜1 mm), as shown in FIG. 1a. Specimens with and without a notch were fixed in two clamps with a distance of 10 mm between them, and then subjected to uniaxial tensile testing with a loading rate of 0.005 mm/mm/s. The fracture toughness (Γ) is given by:

Γ=W_{C}H (S1)

where W_{c} is the integrated area under the stress-strain curve of the unnotched sample in the region from zero strain up until the critical strain (which is the failure strain of the notched sample). His the distance between the two clamps.

The Young's modulus (E) of the elastomers was calculated from the gradient of a straight line fitted to the stress-strain curve of an unnotched sample of the elastomer in the initial region (strain from 0 to 0.05. i.e. in the region where the strain is approximately zero—see FIG. 1b).

### In Situ Scanning Electron Microscopy (SEM) During Stretching

A sample of the polymer film was cut using a homemade stamp-type cutter to obtain a dog-bone specimen (gauge section: 3 mm×4 mm). Afterwards, a sharp pre-crack (length: 0.95 mm) was introduced to the gauge section using a craft knife. Tensile testing was conducted on the specimen in a field emission scanning electron microscopy (FE-SEM). The displacement was applied to the specimen while observing around the crack.

### Transmittance

Transmittance of samples was measured by a spectrophotometer (Cary 14 UV/Vis/NIR) in the wavelength range from 400 nm to 800 nm.

### Thermogravimetric Analysis (TGA)

Thermogravimetric analysis was conducted by using a Netzsch instrument (TG 209F1 Libra). The sample was placed in the crucible and heated from 30° C. to 800° C. with a heating rate of 10° C./min under nitrogen atmosphere.

### Modulated Differential Scanning Calorimetry (MDSC)

DSC experiments were carried out by using a Netzsch instrument (DSC 214 Polyma) at a heating ramps of 5° C./min, and a modulation amplitude of 0.5° C. with a period of 60 s.

### Experimental Part

### Synthesis of Polymer

Several polymers according to the present invention were prepared and subjected to mechanical testing. The prepared polymers are termed PDUE5000, PDUE3000 and PDUE1000 respectively. Scheme 1 shows the reactions effected:

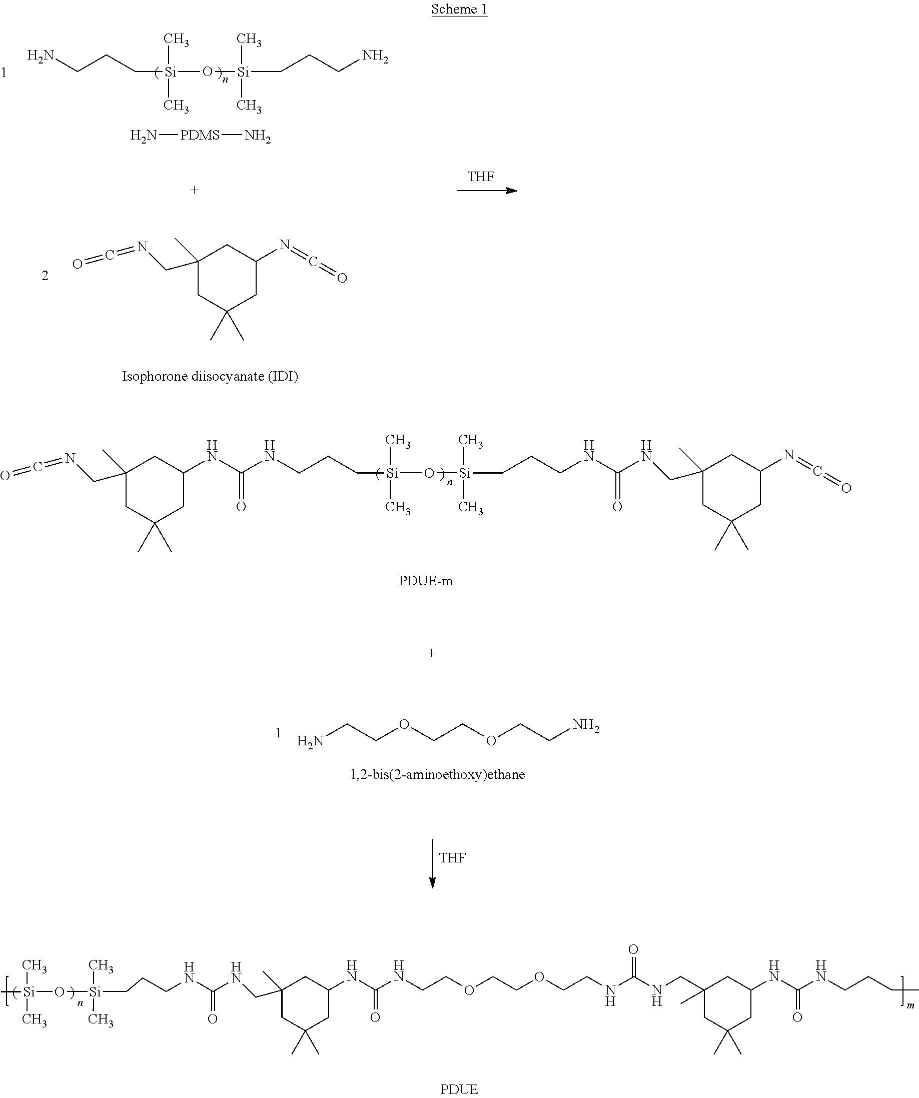

PDUE5000 was synthesised as follows. Aminopropyl terminated polydimethylsiloxane (NH₂-PDMS-NH₂, 75.000 g, 15 mmol, molecular weight: 5000 Dalton, Gelest) was dissolved in tetrahydrofuran (THF, 150 mL, Sigma-Aldrich). The solution was then added dropwise into isophorone diisocyanate (IDI, 6.6684 g, 30 mmol, Sigma-Aldrich) in THF (45 mL) under vigorous stirring. After stirring for 2 h, 0.5 mL of the mixture was pipetted out and evaporated for characterization (the intermediate is termed PDUE-m herein), then 1,2-bis(2-aminoethoxy)ethane (2.223 g, 15 mmol, chain extender, Sigma-Aldrich) in THF (30 mL) was added into the remaining mixture under vigorous stirring. Afterwards, another 20 mL of THF was added into the mixture to lower the viscosity and kept.

After stirring for another 48 h, the viscous mixture was stored for further fabrication or testing.

PDUE3000 and PDUE1000 were prepared followed the same procedure—only using an aminopropyl-terminated PDMS having a molecular weight of 3000 and 1000 Dalton respectively.

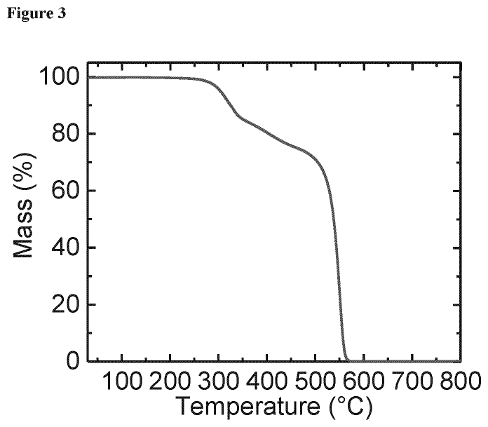

The molecular structures of PDUE-m and PDUEX (where X is the molecular weight of the aminopropyl-terminated PDMS) were confirmed by means of Fourier transform infrared (FTIR) and ¹H nuclear magnetic resonance (NMR) spectroscopy. Thermogravimetric analysis showed no clear degradation below 250° C. (see FIG. 3). The films were clear upon visual inspection and had a transmittance of greater than 90% over the range 400-800 nm when measured according to the transmittance method described herein.

### Comparative Polymer (CE1-PDUQ)

A comparative polymer was prepared by following the synthesis described above using diaminopropyl terminated polydimethylsiloxane (NH₂-PDMS-NH₂, 75.000 g, 15 mmol, molecular weight: 3000 Dalton, Gelest) as the PDMS macromonomer and isophorone diisocyanate (IDI, 6.6684 g, 30 mmol, Sigma-Aldrich) as the diisocyanate but without using a chain extender. The fracture toughness and stiffness of this polymer are reported in Table 1. The stiffness and toughness of this polymer is much lower than that of the inventive polymers.

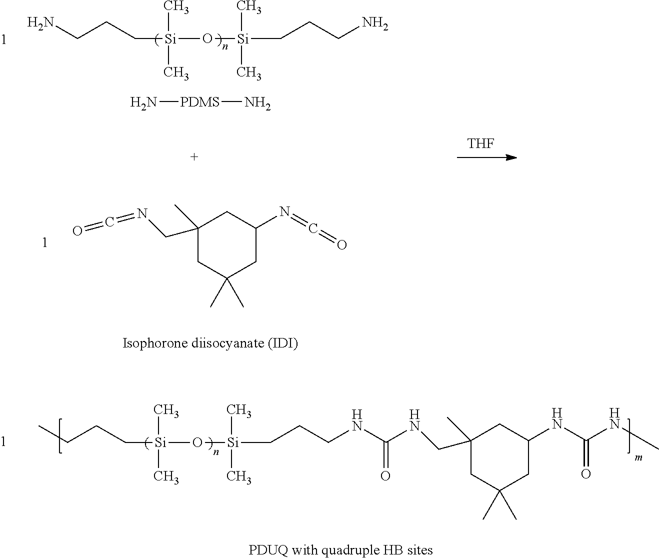

### Fabrication of PDUE Films for Testing

25 mL of the polymer mixture obtained by the method outlined above was poured into a homemade Teflon pool mould with a dimension of 7×7×1 cm³, covered by petri dishes and allowed to dry under ambient conditions for 5 days. At the end of this period, the elastomeric film formed was gently peeled from the mould. Tensile testing was then performed on samples of the polymer film (and on samples of comparative polymer compositions) according to the method described under “Determination methods”. The results of this testing are shown in the table below.

TABLE 1

| | Fracture toughness | Young's modulus |
|---|---|---|
| Sample ID | (J/m²) | (MPa) |
| PDUE5000 | 16434 | 3.2 |
| PDUE3000 | 17016 | 10.3 |
| PDUE1000* | N.A. | N.A. |
| (comparative) | | |
| CE1 | 6854 | 1.6 |

*during the synthesis of PDUE1000, precipitation occurred when adding the chain extender, thereby leading to failure of the synthesis.

As shown by Table 1, the polymers of the inventive examples have unexpectedly high fracture toughness and stiffness (as indicated by the high Young's modulus) when having a structure according to the present invention. In general, there is an inverse relationship between fracture toughness and stiffness, and so there is often a trade-off between these two properties. On the contrary, the inventive examples have high fracture toughness and stiffness. The fracture toughness of PDUE3000 and PDUE5000 is much higher than that of other polymers having equivalent stiffness.

Furthermore, PDUE3000 surprisingly has a Young's modulus more than 3 times higher than that of PDUE5000, without exhibiting a corresponding drop in fracture toughness (the fracture toughness is in fact slightly improved). This unexpected finding forms an additional aspect of the present invention.

The comparative polymer example PDUE1000 on the other hand, having a value of n according to formula (A) of approximately 11 (i.e. less than defined by claim 1), was not successfully synthesised. Without wishing to be bound by theory, it is believed that the failure of the synthesis of PDUE1000 is due to the high concentration of hydrogen bonding sites when using such a short PDMS segment, thereby leading to aggregation and subsequent precipitation of polymer chains in the solution. The high fracture toughness and stiffness of the inventive examples on the other hand is believed to be due to the formation of strong hydrogen bonding domains, which may act to dissipate energy when the material is stretched.

1. A polymer comprising a structural unit of formula (I): 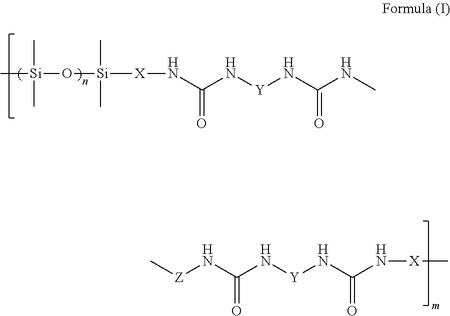
wherein each X is independently a C₁₋₁₀ hydrocarbylene group optionally comprising 1 to 6 heteroatoms;
Y is a C₂₋₂₀ hydrocarbylene group;
Z is a C₁₋₂₀ hydrocarbylene group optionally comprising 1 to 6 heteroatoms or a linking group comprising one or more alkylene glycol or ethylene diamine groups;
n is 12 to 100; and
m is 2 to 1000.

2. The polymer according to claim 1, wherein each X is independently a C1-6 hydrocarbylene group, preferably a C1-4 hydrocarbylene group, such as a C3 hydrocarbylene group.

3. The polymer according to claim 1 or claim 2, wherein each X is independently a C1-6 alkylene group, such as n-propylene.

4. The polymer according to any preceding claim, wherein Y is a C6-20 hydrocarbylene group, preferably a C6-12 hydrocarbylene group.

5. The polymer according to any preceding claim, wherein Y is a C6-12 cycloalkylene group, preferably a branched C6-C12 cycloalkylene group, such as 1,1,3,3-tetramethylcyclohexylene.

6. The polymer according to any preceding claim, wherein Z is
-L1-(OCH₂CH₂O)_{q}-L2-
-L1-(NHCH₂CH₂NH)_{q}-L2-
wherein q is 1 to 10 and L1 and L2 are independently a C1-4 alkylene chain; or
—CH₂(CH₂)_{w}CH₂—
where w is 0-10.
wherein q is 1 to 10 and L1 and L2 are independently C1-6 alkylene groups, such as
—CH₂CH₂OCH₂CH₂OCH₂CH₂—.

7. The polymer according to claim 6 wherein q is 1 and L1 and L2 are ethylene.

8. The polymer according to claims 1 to 7 wherein Z comprises an ether or an amino group, especially a polyether functional group.

9. The polymer according to any preceding claim, having a Young's modulus of greater than 1 MPa, preferably greater than 2 MPa, more preferably greater than 3 MPa, such as greater than 10 MPa.

10. The polymer according to any preceding claim, having a fracture toughness of greater than 5 kJ/m², preferably greater than 10 KJ/m², such as greater than 15 kJ/m².

11. The polymer according to any preceding claim, being an elastomer.

12. The polymer according to any preceding claim, wherein the polymer is a thermoplastic.

13. A polymer composition comprising the polymer according to any preceding claim, preferably an unfilled polymer composition.

14. The polymer according to any preceding claim wherein the molecular weight of the siloxy repeating unit (i.e. the repeating unit within the curved brackets) is preferably at least 1000, such as at least 1200, especially at least 1500.

15. The polymer according to any preceding claim having a melting point measured by DSC of at least 50° C.

16. Use of a polymer or polymer composition according to any preceding claim in the manufacture of films, wearable electronics, flexible electronics, soft robots, vehicles, in construction, and in soft-lithography.

17. An article, such as a film, wearable electronic device, flexible electronic device, soft robot or vehicle, comprising the polymer or polymer composition according to any of claims 1 to 15.

18. A method of preparing a polymer comprising a repeating unit of formula (I) 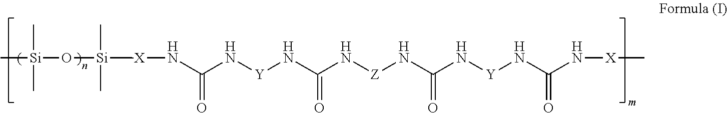
comprising the steps of:
(i) reacting a compound of formula (A) with a compound of formula (B) to form an intermediate of formula (C);
(ii) reacting said intermediate of formula (C) with a chain extender of formula (D) 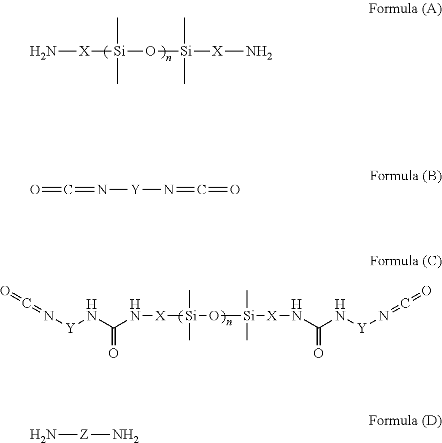
wherein X, Y, Z and n are as defined for the polymer according to formula (I) in claim 1.

19. The method of claim 18, wherein the chain extender of formula (D) is 1,2-bis(2-aminoethoxy)ethane or triethylenetetramine.

20. A polymer comprising a repeating unit of formula (II)
-[PDMS-Q]- (II)
wherein PDMS is a polydimethylsiloxane having an Mw of at least 1200 and Q is a group comprising at least two urea (NH—CO—NH) groups, and at least one alkylene glycol or alkylene diamine group in the backbone of the polymer.

21. The polymer according to claim 20, wherein Q comprises at least 4 urea groups.

22. The polymer according to claim 20 or 21 wherein Q comprises the group
-L1-(OCH₂CH₂O)_{q}-L2- or -L1-(NHCH₂CH₂NH)_{q}-L2-
wherein q is 1 to 10 and L1 and L2 are independently a C1-4 alkylene chain.

23. The polymer according to any of claims 20 to 22, wherein Q comprises the structural unit [chemical structure]
